(19) United States
(12) Patent Application Publication
(10) Pub. No.: US 2003/0166761 A1
(43) Pub. Date: Sep. 4, 2003

(54) Filled thermoplastic moulding materials on the basis of polycarbonate and styrene copolymers

(76) Inventors: Martin Weber, Maikammer (DE); Walter Heckmann, Weinheim (DE); Reinhard Jakobi, Maxdorf (DE); Manfred Knoll, Wachenheim (DE); Xaver Hopfenspirger, Hassloch (DE)

Correspondence Address: KEIL & WEINKAUF, 1350 CONNECTICUT AVENUE, N.W., WASHINGTON, DC, 20036, US

(21) Appl. No.: 10/148,922

(22) PCT Filed: Dec. 6, 2000
(86) PCT No.: PCT/EP00/12285

(30) Foreign Application Priority Data
Dec. 9, 1999 (DE) 199-59-410.4

(51) Int. Cl. C08K 3/26; C08K 3/34

(52) U.S. Cl. 524/447; 524/492; 524/425

(57) ABSTRACT

The thermoplastic molding composition comprises components A, B, C and D, and also, where appropriate, E, F, G and H, the entirety of which gives 100% by weight:

a) from 1 to 97.5% by weight of at least one aromatic polycarbonate A,

b) from 1 to 97.5% by weight of at least one graft polymer B made from

b1) from 40 to 80% by weight of a graft base made from an elastomeric polymer B1 based on alkyl acrylates having from 1 to 8 carbon atoms in the alkyl radical, on ethylene-propylene, on dienes or on siloxanes, and having a glass transition temperature below 0° C.,

b2) from 20 to 60% by weight of a graft B2 made from

b21) from 60 to 95% by weight of styrene or of substituted styrenes B21 of the formula I

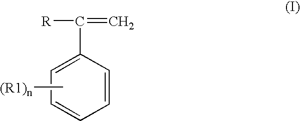

where R is C₁-C₈-alkyl or hydrogen and R¹ is C₁-C₈-alkyl and n is 1, 2 or 3, or a mixture of these, and

b22) from 5 to 40% by weight of at least one unsaturated nitrile B22,

c) from 1 to 97.5% by weight of at least one thermoplastic copolymer C made from

c1) from 60 to 85% by weight of styrene or of substituted styrenes C1 of the formula I, or mixtures of these compounds, and

c2) from 15 to 40% by weight of at least one unsaturated nitrile C2,

d) from 0.5 to 25% by weight of a mixture D made from, based on component D,

d1) from 5 to 95% by weight of at least one particulate mineral filler D1, and

d2) from 5 to 95% by weight of fibrous fillers D2, where at least 50% by weight of the fibrous fillers have a length of at least 50 μm,

and other ingredients where appropriate.

The present invention relates to filled thermoplastic molding compositions based on polycarbonate and on styrene copolymers, to a process for their preparation, and to their use for producing moldings, fibers or films, in particular for producing bodywork parts for the automotive sector.

Polymer blends made from polycarbonate and from styrene polymers, such as ABS (acrylonitrile-butadiene-styrene polymers) or ASA (acrylonitrile-styrene-acrylate polymers) have excellent mechanical properties. These molding compositions are therefore used in a very wide variety of sectors, for example in automotive construction, in the construction of buildings, for office machinery, and also in electrical devices and in household appliances.

For the production of large-surface-area moldings a low coefficient of thermal expansion (CTE) is desirable. The coefficient of thermal expansion can be lowered by adding fillers or reinforcing materials to thermoplastic molding compositions. However, this method also substantially reduces the toughness and the flowability of the products.

EP-B-0 391 413 describes filled polymer mixtures built up from an aromatic polycarbonate and from a rubber-modified polymer. They comprise from 4 to 18% by weight of inorganic fillers, in which at least 98% by weight of the filler particles in the polymer blend have a particle diameter below 44 μm. The average diameter to thickness ratio for these filler particles is said to be from 4 to 24. Use is particularly made of specifically selected non-calcined clays, and use is also made of mixtures of a number of different clays and talc. The use of fibrous reinforcing materials, such as glass fibers, is deprecated, since they are said to lead to unacceptable surface properties and to be visible on the surfaces of the moldings.

EP-B-0 135 904 relates to polyethylene terephthalate/polycarbonate blends which have talc (a magnesium silicate) as filler. The molding compositions are composed of polyethylene terephthalate, of a thermoplastic aromatic polycarbonate, of a graft-modified rubber based on butadiene, and of from 0.1 to 4% of talc.

Wo 96/06136 relates to filled polycarbonate blend compositions. Blends made from a polycarbonate and from a monovinylidene-aromatic copolymer are described, and these comprise no graft rubber, but they do also comprise an inorganic filler which has an average particle size below 10 μm, the average ratio of diameter to thickness being from 4 to 30.

Talc and clay are listed as fillers.

The molding compositions described do not have a property profile suitable for all applications—low coefficient of thermal expansion but adequate toughness and flowability.

Another problem encountered when processing the filled molding compositions described to give large-surface-area parts is that of surface defects in the region of the gate.

It is an object of the present invention, therefore, to provide molding compositions based on polycarbonate, on styrene copolymers and on fillers and/or reinforcing materials, having not only reduced thermal expansion but also good toughness, in particular fracture energy at −30° C., and also high elongation at break and notch impact strength at room temperature. In addition, alongside good dimensional stability and high toughness, they should also have very good flowability. The surface quality in the region of the gate should also preferably be improved.

We have found that this object is achieved by using a specific combination made from mineral particulate fillers and from glass fibers, in polymer blends based on polycarbonate and on styrene copolymers, to reduce thermal expansion while obtaining good toughness, in particular fracture energy at −30° C., and also high elongation at break and notch impact strength at room temperature. The molding compositions also have very good flowability and improved surface quality in the region of the gate.

The invention provides thermoplastic molding compositions comprising components A, B, C and D, and also, where appropriate, E, F, G and H, the entirety of which gives 100% by weight:

a) from 1 to 97.5% by weight of at least one aromatic polycarbonate A,

b) from 1 to 97.5% by weight of at least one graft polymer B made from

b1) from 40 to 80% by weight of a graft base made from an elastomeric polymer B1 based on alkyl acrylates having from 1 to 8 carbon atoms in the alkyl radical, on ethylene-propylene, on dienes or on siloxanes, and having a glass transition temperature below 0° C.,

b2) from 20 to 60% by weight of a graft B2 made from

b21) from 60 to 95% by weight of styrene or of substituted styrenes B21 of the formula I

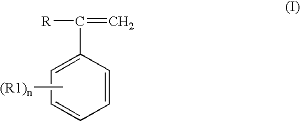

where R is C₁-C₈-alkyl or hydrogen and R¹ is C₁-C₈-alkyl and n is 1, 2 or 3, or a mixture of these, and

b22) from 5 to 40% by weight of at least one unsaturated nitrile B22,

c) from 1 to 97.5% by weight of at least one thermoplastic copolymer C made from

c1) from 60 to 85% by weight of styrene or of substituted styrenes C1 of the formula I, or mixtures of these compounds, and

c2) from 15 to 40% by weight of at least one unsaturated nitrile C2,

d) from 0.5 to 25% by weight of a mixture D made from

d1) from 5 to 95% by weight of at least one particulate mineral filler D1, and

d2) from 5 to 95% by weight of fibrous fillers D2, preferably glass fibers, where at least 50% by weight of the fibrous fillers have a length of at least 50 μm,

e) from 0 to 10% by weight of at least one copolymer E made from at least two different alkyl esters, from aromatic or alkylaromatic esters of acrylic acid or of methacrylic acid,

f) from 0 to 25% by weight of at least one thermoplastic polyester F,

g) from 0 to 2% by weight of at least one low-molecular-weight organic acid G,

h) from 0 to 25% by weight of at least one halogen-free phosphorus compound H,

i) from 0 to 45% by weight of other additives I.

The preferred components A to I are described below.

Component A

Component A is present in the molding compositions of the invention in amounts of from 1 to 97.5% by weight, preferably from 10 to 93% by weight, in particular from 45 to 65% by weight.

Halogen-free polycarbonates are preferably used as component A. Examples of suitable halogen-free polycarbonates are those based on biphenols of the formula II

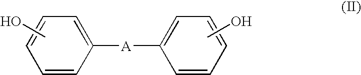

where A is a single bond, C₁-C₃-alkylene, C₂-C₃-alkylidene, C₃-C₆-cycloalkylidene, or else —S— or —SO₂—.

Examples of preferred biphenols of the formula II are hydroquinone, resorcinol, 4,4′-dihydroxyphenol, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)-cyclohexane, and also to 1,1-bis(4-hydroxyphenyl)-3,3,5-trimethylcyclohexane.

Either homopolycarbonates or copolycarbonates are suitable as component A, and preference is given to the copolycarbonates of bisphenol A, as well as to bisphenol A homopolycarbonate.

Suitable polycarbonates may have branching in a known manner, preferably via incorporation of from 0.05 to 2.0 mol %, based on the entirety of the biphenols used, of at least trifunctional compounds, for example those having three or more than three phenolic OH groups.

Polycarbonates which have proven to be particularly suitable have relative viscosities ηᵣₑₗ of from 1.10 to 1.50, in particular from 1.25 to 1.40. This corresponds to average molecular weights M_{w} (weight-average) of from 10 000 to 200 000, preferably from 20 000 to 80 000.

The biphenols of the formula II are known per se or can be prepared by known methods.

One method of preparing the polycarbonates is to react the biphenols with phosgene by the interfacial process, or with phosgene by the homogeneous-phase process (known as the pyridine process), and an appropriate amount of known chain terminators can be used in each case to achieve the desired molecular weight. (For polydiorganosiloxane-containing polycarbonates, see DE-A 33 34 782, for example).

Examples of suitable chain terminators are phenol, p-tert-butylphenol, and also long-chain alkylphenols, such as 4-(1,3-tetramethylbutyl)phenol, as in DE-A 28 42 005, or monoalkylphenols or dialkylphenols having a total of from 8 to 20 carbon atoms in the alkyl substituents, as in DE-A 35 06 472, for example p-nonylphenol, 3,5-di-tert-butylphenol, p-tert-octyl-phenol, p-dodecylphenol, 2-(3,5-dimethylheptyl)phenol and 4-(3,5-dimethylheptyl)phenol.

For the purposes of the present invention, a halogen-free polycarbonate is a polycarbonate built up from halogen-free biphenols, from halogen-free chain terminators and, where appropriate, from halogen-free branching agents. Any minor ppm content here of hydrolyzable chlorine, resulting, for example, from the preparation of the polycarbonates with phosgene in the interfacial process, is not to be regarded as meriting the term halogen-containing for the purposes of the present invention. Polycarbonates of this type with ppm contents of hydrolyzable chlorine are halogen-free polycarbonates for the purposes of the present invention.

Component B

Component B is present in the molding compositions of the invention in amounts of from 1 to 97.5% by weight, preferably from 3 to 50% by weight, in particular from 10 to 30% by weight. Component B is preferably halogen-free.

The graft polymer B has been built up from

b1) from 40 to 80% by weight, preferably from 50 to 70% by weight, of a graft base made from an elastomeric polymer B1 based on alkyl acrylates having from 1 to 8 carbon atoms in the alkyl radical, on ethylene-propylene, on dienes or on siloxanes, and having a glass transition temperature below 0° C.,

b2) from 20 to 60% by weight, preferably from 30 to 50% by weight, of a graft B2 made from

b21) from 60 to 95% by weight, preferably from 70 to 85% by weight, of styrene or of substituted styrenes B21 of the formula I

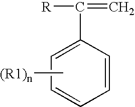

where R is C₁-C₈-alkyl, preferably methyl or ethyl, or hydrogen, and R¹ is C₁-C₈-alkyl, preferably methyl or ethyl, and n is 1, 2 or 3, or a mixture of these, and

b22) from 5 to 40% by weight, preferably from 15 to 30% by weight, of at least one unsaturated nitrile B22, preferably acrylonitrile or methacrylonitrile or a mixture of these.

Polymers which may be used for the graft base B1 are those whose glass transition temperature is below 10° C., preferably below 0° C., particularly preferably below −20° C. Examples of these are elastomers based on C₁-C₈-alkyl esters of acrylic acid, if desired containing other comonomers, based on ethylene-propylene, based on dienes, such as butadiene, or based on siloxanes. The resultant graft rubbers are then, respectively, ASA rubbers, AES rubbers, ABS rubbers and polysiloxane rubbers.

Preferred graft bases B1 are those which have been built up from

b11) from 70 to 99.9% by weight, preferably from 69 to 79% by weight, of at least one alkyl acrylate B11 having from 1 to 8 carbon atoms in the alkyl radical, preferably n-butyl acrylate and/or 2-ethylhexyl acrylate, in particular n-butyl acrylate as sole alkyl acrylate,

b12) from 0 to 30% by weight, in particular from 20 to 30% by weight, of another copolymerizable monoethylenically unsaturated monomer B12, such as butadiene, isoprene, styrene, acrylonitrile, methyl methacrylate or vinyl methyl ether, or a mixture of these, and

b13) from 0.1 to 5% by weight, preferably from 1 to 4% by weight, of a copolymerizable, polyfunctional, preferably bi- or trifunctional, crosslinking monomer B13, the entirety of B11, B12 and B13 giving 100% by weight.

Suitable bi- or polyfunctional crosslinking monomers B13 of this type are those which contain preferably two, where appropriate three or more, ethylenic double bonds capable of copolymerization and not 1,3-conjugated. Examples of suitable crosslinking monomers are divinylbenzene, diallyl maleate, diallyl fumarate, diallyl phthalate, triallyl cyanurate and triallyl isocyanurate. The acrylic ester of tricyclodecenyl alcohol has proven to be a particularly useful crosslinking polymer (cf. DE-A 12 60 135).

This type of graft base is known per se and described in the literature, for example in DE-A 31 49 358.

Among graft bases B2, preference is given to those in which B21 is styrene or α-methylstyrene or a mixture of these, and B22 is acrylonitrile or methacrylonitrile.

Particularly preferred monomer mixtures are styrene and acrylonitrile or a-methylstyrene and acrylonitrile. The grafts are obtainable by copolymerizing components B21 and B22.

In the graft polymers B, the graft base B1 built up from the components B11 and, where appropriate, B12 and B13 is also termed an ASA rubber. Its preparation is known per se and is described DE-A 28 26 925, DE-A 31 49 358 and DE-A 34 14 118, for example.

The graft polymers B may be prepared by the method described in DE-C 12 60 135, for example.

The structure of the graft (graft shell) of the graft polymers may be single-stage or two-stage.

In the case of a single-stage structure of the graft shell, a mixture of the monomers B21 and B22 in the desired ratio by weight within the range from 95:5 to 50:50, preferably from 90:10 to 65:35, is polymerized in a manner known per se (cf. DE-A 28 26 925, for example), preferably in emulsion, in the presence of the elastomer B1.

In the case of a two-stage structure of the graft shell B2, the 1^{st} stage generally makes up from 20 to 70% by weight, preferably from 25 to 50% by weight, based on B2. It is preferable for the material used for its preparation to be solely styrene or substituted styrenes or a mixture of these B21.

The 2^{nd} stage of the graft shell generally makes up from 30 to 80% by weight, in particular from 50 to 75% by weight, based in each case on B2. It is prepared using mixtures made from the monomers B21 and from the nitrites B22 in a weight ratio B21/B22 of generally from 90:10 to 60:40, in particular from 80:20 to 70:30.

The conditions selected for the graft polymerization are preferably such that the resultant particle sizes are from 50 to 700 nm (d₅₀ for the cumulative mass distribution). Measures for this purpose are known and described in DE-A 28 26 925, for example.

A coarse-particle rubber dispersion may be prepared directly by the seed-latex process.

To obtain very tough products, it is frequently advantageous to use a mixture of at least two graft polymers with different particle sizes.

To achieve this, the particles of the rubber are enlarged in a known manner, e.g. by agglomeration, to give the latex a bimodal structure (from 50 to 180 nm and from 200 to 700 nm).

In one preferred embodiment, a mixture made from two graft polymers with particle diameters (d₅₀ of the cumulative mass distribution) of from 50 to 180 nm and, respectively, from 200 to 700 nm are used in a weight ratio of from 70:30 to 30:70.

The chemical structure of the two graft polymers is preferably identical, but the shell of the coarse-particle graft polymer may in particular also be built up in two stages.

Mixtures made from components A and B in which the latter comprises a coarse-particle and a fine-particle graft copolymer are described in DE-A 36 15 607, for example. Mixtures of components A and B where the latter has a two-stage graft shell are known from EP-A-0 111 260.

Component C

Component C is present in the molding compositions of the invention in amounts of from 1 to 97.5% by weight, preferably from 3 to 50% by weight, in particular from 10 to 30% by weight. It is preferably halogen-free.

According to the invention, the copolymer C has been made from

c1) from 60 to 85% by weight, preferably from 70 to 85% by weight, of styrene or of substituted styrenes C1 of the formula I given above, or a mixture of these, and

c2) from 15 to 40% by weight, preferably from 15 to 30% by weight, of at least one unsaturated nitrile C2, preferably acrylonitrile or methacrylonitrile or a mixture of these.

The copolymers C are resin-like, thermoplastic and rubber-free. Particularly preferred copolymers C are those made from styrene and acrylonitrile, made from α-methylstyrene and acrylonitrile, or made from styrene, α-methylstyrene and acrylonitrile. It is also possible for two or more of the copolymers described to be used simultaneously.

Copolymers of this type frequently arise as by-products during the graft polymerization to prepare component B, especially when large amounts of monomers are grafted onto small amounts of rubber.

Copolymers C are known per se and can be prepared by free-radical polymerization, in particular emulsion polymerization, suspension polymerization, solution polymerization or bulk polymerization. They have viscosity numbers within the range from 40 to 160 ml/g, preferably from 60 to 110 ml/g (measured in 0.5% strength DMF solution at 23° C.), and this corresponds to average molecular weights M_{w} (weight-average) of from 40 000 to 2 000 000.

Component D

Component D is present in the molding compositions of the invention in amounts of from 0.5 to 25% by weight, preferably from 1 to 20% by weight, in particular from 10 to 17.5% by weight.

The proportion of component D1 is preferably from 5 to 95% by weight, in particular from 5 to 90% by weight, and the proportion of component D2 is preferably from 5 to 95% by weight, and in particular from 10 to 95% by weight, based on component D.

Suitable particulate mineral fillers D1 are amorphous silicas, carbonates, such as magnesium carbonate or chalk, powdered quartz, mica, a very wide variety of silicates, such as clays, muskovite, biotite, suzoite, tin maletite, talc, chlorite, phlogophite, feldspar, and calcium silicates, such as wollastonite, or kaolin, particularly calcined kaolin.

In one particularly preferred embodiment, use is made of particulate fillers in which at least 95% by weight, preferably at least 98% by weight, of the particles have a diameter (largest dimension), determined on the finished product, of below 45 μm, preferably below 40 μm, and an aspect ratio preferably within the range from 1 to 25, preferably within the range from 2 to 20, determined on the finished product, i.e. generally on an injection molding.

An example of a method for determining the particle diameters here is to take electron micrographs of thin layers of the polymer mixture and to utilize at least 25 filler particles, preferably at least 50 filler particles, for the evaluation. The particle diameters may also be determined by sedimentation analysis as in Transactions of ASAE, p. 491 (1983). The proportion by weight of the fillers below 40 μm can also be measured by a screening-analysis method. The aspect ratio is the ratio of particle diameter to thickness (largest dimension to smallest dimension).

Particularly preferred particulate fillers are talc, kaolin, such as calcined kaolin, wollastonite, or a mixture made from two or from all of these fillers. Particularly preferred among these is talc with a proportion of at least 95% by weight of particles with a diameter below 40 μm and with an aspect ratio of from 1.5 to 25, always determined on the finished product. Kaolin preferably has a proportion of at least 95% by weight of particles with a diameter below 20 μm, and with an aspect ratio of from 1.2 to 20, always determined on the finished product.

As component D2, use is made of fibrous fillers, such as carbon fibers, potassium titanate whiskers, aramid fibers, or preferably glass fibers, at least 50% by weight of the fibrous fillers (glass fibers) having a length above 50 μm. The (glass) fibers used may preferably have a diameter of up to 25 μm, particularly preferably from 5 to 13 μm. It is preferable for at least 70% by weight of the glass fibers to have a length above 60 μm. It is particularly preferable for the average length of the glass fibers in the finished molding to be from 0.08 to 0.5 mm. The length of the glass fibers is based on a finished molding, for example obtained by injection molding. The glass fibers here may have been cut to length already when added to the molding compositions, or else be added as continuous strands (rovings).

Component E

Component E is used in the molding compositions of the invention in amounts of from 0 to 10% by weight, preferably from 0 to 5% by weight.

According to the invention, the copolymers E have been built up from at least two different alkyl, aromatic or alkylaromatic esters of acrylic acid or of methacrylic acid, or a mixture of these.

The alkyl radical in the esters generally has from 1 to 10 carbon atoms, preferably from 1 to 8 carbon atoms. The alkyl radical may be either linear or else branched. The alkyl radicals include methyl, ethyl, n-propyl, isopropyl, n-butyl, isobutyl, t-butyl, n-pentyl, 2-ethylhexyl and cyclohexyl. Preference is given to the use of methyl methacrylate, cyclohexyl methacrylate, n-butyl acrylate or 2-ethylhexyl acrylate. Among the aromatic esters, preference is given to esters having from 6 to 18 carbon atoms, and among these in particular the phenyl radical. Particular preference is given to copolymers E which contain from 70 to 99% by weight, in particular from 80 to 93% by weight, of methyl methacrylate and from 1 to 30% by weight, in particular from 7 to 20% by weight, of n-butyl acrylate.

According to the invention, the polymers E have a high molar mass. They generally have molar masses (weight-average M_{w}) of at least 1,000,000 g/mol (measured by gel permeation chromatography in tetrahydrofuran against a polystyrene standard). Preferred copolymers E have molar masses M_{w} of 1,000,000 g/mol or above, for example at least 1,200,000 g/mol. The copolymers E generally have a glass transition temperature within the range from 40 to 125° C., preferably from 70 to 120° C. determined by DSC measurements at a heating rate of 10 K/min, second cycle after heating to 175° C. and cooling to room temperature).

Component F

Component F is used in the novel molding compositions in amounts from 0 to 25% by weight, preferably from 0 (if present, from 10) to 20% by weight.

As component F it is preferable to use a thermoplastic polyester with aliphatic diol units.

For the purposes of the present invention, a thermoplastic polyester F is not a polycarbonate as may be used as component A. The thermoplastic polyesters preferably derive from aliphatic dihydroxy compounds and from aromatic dicarboxylic acids.

One group of preferred partly aromatic polyesters F is that of polyalkylene terephthalates having from 2 to 10 carbon atoms in the alcohol moiety.

Polyalkylene terephthalates of this type are known per se and described in the literature. Their main chain contains an aromatic ring which comes from the aromatic dicarboxylic acid as described above. The aromatic ring may also have substitution, for example by halogens, such as chlorine or bromine, or by C₁-C₄-alkyl groups.

These polyalkylene terephthalates may also be prepared by reacting aromatic dicarboxylic acids, or their esters or other ester-forming derivatives, with aliphatic dihydroxy compounds in a manner known per se.

It is, of course, also possible to use mixtures of polyalkylene terephthalates with fully aromatic polyesters. These generally comprise from 20 to 98% by weight of the polyalkylene terephthalates and from 2 to 80% by weight of the fully aromatic polyester.

The aromatic dicarboxylic acids generally have from 8 to 30 carbon atoms. The aromatic ring(s) may have substitution, e.g. with one or more C₁-C₄-alkyl radicals, such as methyl, ethyl, n-propyl, isopropyl, n-butyl, isobutyl or tert-butyl. Preferred aromatic dicarboxylic acids are terephthalic acid, isophthalic acid and 2,6-naphthalenedicarboxylic acid. Preference is given to mixtures made from 5 to 100 mol % of isophthalic acid and from 0 to 95 mol % of terephthalic acid, in particular mixtures of from 20 to 50 mol % of isophthalic acid and from 50 to 80 mol % of terephthalic acid.

Preferred dicarboxylic acids are 2,6-naphthalene-dicarboxylic acid, terephthalic acid and isophthalic acid, and mixtures of these. Aliphatic or cycloaliphatic dicarboxylic acids, such as adipic acid, azelaic acid, sebacic acid, dodecanedioic acids and cyclohexanedicarboxylic acids, may replace up to 30 mol %, preferably not more than 10 mol %, of the aromatic dicarboxylic acids.

Among the aliphatic dihydroxy compounds, preference is given to diols having from 2 to 6 carbon atoms, in particular 1,2-ethanediol, 1,4-butanediol, 1,6-hexanediol, 1,4-hexanediol, 1,4-cyclohexanediol, 1,4cyclohexanedimethylol and neopentyl glycol, and mixtures of these.

Particularly preferred thermoplastic polyesters F are polyalkylene terephthalates which derive from alkanediols having from 2 to 6 carbon atoms. Among these, particular preference is given to polyethylene terephthalate, polytrimethylene terephthalate and polybutylene terephthalate, and mixtures of these.

The viscosity number of the polyesters F is generally within the range from 70 to 220, preferably from 100 to 150 (measured at 25° C. in a 0.5% strength by weight solution in a mixture of phenol and o-dichlorobenzene (weight ratio 1:1)).

Particularly preferred polyesters are those whose carboxyl end group content is up to 100 mval/kg, preferably up to 50 mval/kg, in particular up to 40 mval/kg of polyester. Polyesters of this type may be prepared by the process of DE-A 44 01 055, for example. The carboxyl end group content is usually determined by titration methods (e.g. potentiometry).

Component G

Component G is present in the molding compositions of the invention in amounts of from 0 to 2% by weight, preferably from 0 to 1.8% by weight, in particular from 0 (if present, from 0.1) to 0.5% by weight.

Component G is a low-molecular-weight, halogen-free organic acid.

For the purposes of the present invention, low-molecular-weight compounds include polynuclear compounds, for example compounds having up to five nuclei, in particular monomeric compounds.

According to the invention, the acids are halogen-free, i.e. contain no halogens in their molecular skeleton. However, the invention does include acids which have small amounts of halogen-containing contamination.

For the purposes of the present invention, acids include acid hydrates.

It is advantageous to use acids which at the processing temperatures used are involatile or at low volatility and, respectively, do not decompose at temperatures up to about 300° C.

The acids may contain one, two or more acid groups, for example up to ten acid groups.

It is preferable to use organic acids. Use may be made of either aromatic or else aliphatic acids. It is also possible to use aliphatic/aromatic acids. Preferred acids include palmitic acid, stearic acid, benzoic acid, isophthalic acid, terephthalic acid, trimellitic acid, sulfonic acids, such as p-toluenesulfonic acid, fumaric acid, citric acid, mandelic acid and tartaric acid.

It is particularly preferable to use citric acid or p-toluenesulfonic acid or a mixture of these, for example one in which the proportion by weight of the citric acid is from 1 to 99% by weight, preferably from 10 to 90% by weight, and that of the p-toluenesulfonic acid is correspondingly from 1 to 99% by weight, preferably from 10 to 90% by weight.

Component H

Component H is present in the molding compositions of the invention in amounts of from 0 to 25% by weight, preferably from 0 to 20% by weight, in particular from 0 (if present, from 0.2) to 10% by weight.

Any of the known conventional phosphorus-containing flame retardants may be used as component H. It is preferable to use the flame retardants listed in DE-A-40 34 336 and/or those listed in EP-A 0 552 397. Examples of these are tris(2,6-dimethylphenyl) phosphate, triphenyl phosphate, tricresyl phosphate, diphenyl 2-ethylcresyl phosphate, diphenyl cresyl phosphate, tris-(isopropylphenyl) phosphate, and also bis(phenyl) 4-phenylphenyl phosphate, phenyl bis(4-phenylphenyl) phosphate, tris(4-phenylphenyl) phosphate, bis(phenyl) benzylphenyl phosphate, phenyl bis(benzylphenyl) phosphate, tris(benzylphenyl) phosphate, phenyl bis[1-phenylethylphenyl] phosphate, phenyl bis[1-methyl-1-phenylethylphenyl] phosphate and phenyl bis[4-(1-phenethyl)-2,6-dimethylphenyl] phosphate. They may also be used in a mixture with triphenylphosphine oxide or tris(2,6-dimethylphenyl)phosphine oxide.

Preferred flame retardants however are resorcinol diphosphate and, correspondingly, higher oligomers, hydroquinone diphosphate and corresponding higher oligomers.

Reference may also be made to the compounds described in EP-A-0 103 230, EP-A-0 174 493, EP-A-0 206 058, EP-A-0 363 608 and EP-A-0 558 266.

Component I

Component I is used in amounts of from 0 to 45% by weight, preferably from 0 to 20% by weight, in particular from 0 (if present, from 0.4) to 10% by weight.

Examples of other additives are processing aids, stabilizers and oxidation retarders, agents to inhibit decomposition caused by heat or by ultraviolet light, lubricants, mold-release agents, flame retardants, dyes, pigments and plasticizers. Their proportion is generally from 0 to 45% by weight, preferably from 0 to 20% by weight, in particular from 0 (if present, from 0.2) to 10% by weight, based on the total weight of the composition.

Pigments and dyes are generally present in amounts of from 0 to 4% by weight, preferably from 0 to 3.5% by weight and in particular from 0 (if present, from 0.5) to 3% by weight.

The pigments for pigmenting thermoplastics are well known (see, for example, R. Gachter and H. Müller, Taschenbuch der Kunststoffadditive, Carl Hanser Verlag, 1983, pp. 494-510). The first preferred group of pigments is that of white pigments, such as zinc oxide, zinc sulfide, white lead (2 PbCO₃.Pb(OH)₂), lithopones, antimony white and titanium dioxide. Of the two most commonly found crystalline forms of titanium dioxide (rutile and anatase) it is in particular the rutile form which is used for white coloration of the molding compositions of the invention.

Black color pigments which may be used according to the invention are iron oxide black (Fe₃O₄), spinel black (Cu(Cr,Fe)₂O₄), manganese black (a mixture of manganese dioxide, silicon oxide and iron oxide), cobalt black and antimony black, and also particularly preferably carbon black, mostly used in the form of furnace black or gas black (see in this connection G. Benzing, Pigmente für Anstrichmittel, Expert-Verlag (1988), p. 78 et seq.).

According to the invention, it is, of course, also possible to achieve particular shades by using inorganic non-black colored pigments, such as chromium oxide green, or organic non-black color pigments, such as azo pigments or phthalocyanines. Pigments of this type are widely available commercially.

It may moreover be advantageous to use a mixture of the pigments and, respectively, dyes mentioned, e.g. carbon black with copper phthalocyanines, since the dispersion of color in the thermoplastic generally becomes easier.

Examples of oxidation retarders and heat stabilizers which may be added to the thermoplastic materials according to the invention are halides of metals of group I of the Periodic Table, e.g. sodium halides and lithium halides, where appropriate in combination with copper(I) halides, e.g. with chlorides, bromides or iodides. The halides, in particular of copper, may also contain electron-rich π ligands. Examples of copper complexes of this type are Cu halide complexes with, for example, triphenylphosphine. It is also possible to use zinc fluoride and zinc chloride. Use may also be made of sterically hindered phenols, hydroquinones, substituted representatives of this group, secondary aromatic amines, where appropriate in combination with phosphorus-containing acids and, respectively, salts of these, and mixtures of these compounds, preferably in concentrations up to 1% by weight, based on the weight of the mixture.

Examples of UV stabilizers are various substituted resorcinols, salicylates, benzotriazoles and benzophenones, which are usually used in amounts of up to 2% by weight.

Lubricants and mold-release agents, generally used in amounts of up to 1% by weight of the thermoplastic material, are stearic acid, stearyl alcohol, alkyl stearates and stearamides, and also esters of pentaerythritol with long-chain fatty acids. It is also possible to use the stearates of calcium, of zinc or of aluminum, or else dialkyl ketones, e.g. distearyl ketone. Use may moreover be made of ethylene oxide-propylene oxide copolymers as lubricants and mold-release agents.

It is particularly advantageous to use UV stabilizers and heat stabilizers for polycarbonate and styrene copolymers. Examples of suitable stabilizers are also listed in DE-A-44 19 897. Transesterification inhibitors may also be present, for example phosphates, phosphites or phosphonites.

The thermoplastic molding compositions of the invention are prepared by processes known per se, by mixing the components. It may be advantageous to premix individual components. It is also possible for the components to be mixed in solution, with removal of the solvents. Examples of suitable organic solvents are chlorobenzene, mixtures of chlorobenzene and methylene chloride, and mixtures of chlorobenzene and aromatic hydrocarbons, such as toluene. It is preferable to work without chlorinated solvents. One way of concentrating the solvent mixtures by evaporation is to use vented extruders.

Any known method may be used to mix the, for example dry, components A to D and, where appropriate, E to I. It is preferable to mix at 200 to 320° C. by joint extrusion, kneading or roll-milling of the components, the components having been isolated in advance, where appropriate, from the solution obtained during the polymerization, or from the aqueous dispersion.

The thermoplastic molding compositions of the invention may be processed by known methods of thermoplastic processing, for example by extrusion, injection molding, calendering, blow molding or sintering.

The molding compositions of the invention may be used to produce films, fibers or moldings. They may moreover particularly preferably be used to produce bodywork parts in the automotive sector, in particular for producing large-surface-area automotive parts.

The invention also provides corresponding moldings, fibers or films, and also bodywork parts of motor vehicles.

The examples below give further illustration of the invention.

### EXAMPLES

The median particle size and the particle size distribution were determined from the cumulative weight distribution, using a specimen which had been ashed and dispersed by ultrasound. The median particle sizes are in all cases the ponderal median particle sizes, as determined using an analytical ultracentrifuge and the method of W. Scholtan and H. Lange, Kolloid-Z, and Z.-Polymere 250 (1972), pp. 782-796. The ultra-centrifuge measurement gives the cumulative weight distribution of the particle diameter in a specimen. From this it can be deduced what percentage by weight of the particles has a diameter smaller than or equal to a particular size. The median particle diameter, also termed the d₅₀ of the cumulative weight distribution, is defined here as that particle diameter at which the diameter of 50% by weight of the particles is smaller than the diameter corresponding to the d₅₀.

Similarly, the diameter of 50% by weight of the particles is then greater than the d₅₀. To describe the breadth of the particle size distribution of the rubber particles, the d₁₀ and d₉₀ deriving from the cumulative weight distribution are utilized alongside the d₅₀ (median particle diameter). The definitions here for the d₁₀ and, respectively, d₉₀ of the cumulative mass distribution are analogous to the d₅₀, but refer to 10 and, respectively, 90% by weight of the particles. The quotient Q=(d₉₀-d₁₀)/d₅₀ is a measure of the breadth of distribution of particle size.

The following components were used:

A: A commercially available polycarbonate based on bisphenol A, with a viscosity number of 61.3 ml/g, measured at 23° C. on a 0.5% strength by weight solution in methylene chloride.

B1: A fine-particle graft polymer prepared from

β1) 16 g of butyl acrylate and 0.4 g of tricyclodecenyl acrylate, which had been heated to 60° C. in 150 g of water with addition of 1 g of the sodium salt of a C₁₂-C₁₈ paraffinsulfonic acid, 0.3 g of potassium persulfate, 0.3 g of sodium hydrogencarbonate and 0.15 g of sodium pyrophosphate, with stirring. 10 minutes after the start of the polymerization reaction, and within a period of 3 hours, a mixture made from 82 g of butyl acrylate and 1.6 g of tricyclodecenyl acrylate was added. Once monomer addition had ended, stirring was continued for one hour. The resultant latex of the crosslinked butyl acrylate polymer had a solids content of 40% by weight, the median particle size (ponderal median) was determined as 76 nm, and the particle size distribution was narrow (quotient Q=0.29).

β2) 150 g of the polybutyl acrylate latex obtained as in β1) were mixed with 40 g of a mixture made from styrene and acrylonitrile (weight ratio 75:25) and with 60 g of water, and heated at 65° C. for 4 hours, with stirring, after addition of a further 0.03 g of potassium persulfate and 0.05 g of lauroyl peroxide. Once the graft copolymerization had ended, the polymerization product was precipitated from the dispersion by calcium chloride solution at 95° C., washed with water and dried in a stream of warm air. The degree of grafting of the graft copolymner was 35%, and the particle size was 91 nm.

B2: A coarse-particle graft polymer prepared as follows:

β3) The following materials were added at 60° C. over the course of 3 hours to an initial charge made from 1.5 g of the latex prepared as in β1, and following addition of 50 g of water and 0.1 g of potassium persulfate: firstly a mixture made from 49 g of butyl acrylate and 1 g of tricyclodecenyl acrylate, and secondly a solution of 0.5 g of the sodium salt of a C₁₂-C₁₈ paraffinsulfonic acid in 25 g of water. Polymerization was then continued for 2 hours. The resultant latex of the crosslinked butyl acrylate polymer had a solids content of 40%. The median particle size (ponderal median) of the latex was determined as 430 nm, and the particle size distribution was narrow (Q=0.1).

β4) 150 g of the latex prepared as in β3 were mixed with 20 g of styrene and with 60 g of water, and heated for 3 hours at 65° C., with stirring, after addition of a further 0.03 g of potassium persulfate and 0.05 g of lauroyl peroxide. The dispersion obtained during this graft copolymerization was then polymerized for a further 4 hours with 20 g of a mixture made from styrene and acrylonitrile in a weight ratio of 75:25. The reaction product was then precipitated from the dispersion by a calcium chloride solution at 95° C., isolated, washed with water and dried in a stream of warm air. The degree of grafting of the graft copolymer was determined as 35%, and the median particle size of the latex particles was 510 nm.

C: Copolymer made from 81% by weight of styrene and 19% by weight of acrylonitrile with a viscosity number of 72 ml/g (measured at 23° C. in a 0.5% strength by weight solution in dimethylformamide).

D1: IT-Extra talc, manufactured by Norwegian Talc X₁₀=1.7 μm, X₉₀ =10.82 μm [determined by laser diffraction, for which the minerals were uniformly distributed, in a suspension cell, in a demineralized water/1% strength CV-K8 surfactant mixture (marketed by: CV-Chemievertrieb, Hanover) (magnetic stirrer, rotation rate 60 min^{31 1})].

pH of the aqueous suspension: 8.5

D2: Glass fiber with an epoxysilane size and with a fiber diameter of 10 μm and a staple length of 4.5 mm (e.g. PPG 3786).

D3: Glass fiber with an epoxysilane size and with a fiber diameter of 6 μm and a staple length of 4.5 mm

F: Polybutylene terephthalate, e.g. Ultradur® B 4500 from BASF AG, characterized by a viscosity number of 130 (measured in a 0.5% strength by weight solution made from phenol and o-dichlorobenzene).

G: Citric acid hydrate, purity 99%, from Aldrich

I1: A high-molecular-weight multicomponent ester with a viscosity of from 110 to 150 mpa*s at 80° C. (Loxiol®G 70S from Henkel).

I2: Irgaphos PEP Q (biphosphonite from Ciba-Geigy)

Preparation of the thermoplastic molding compositions

Components A to H were mixed in a twin-screw extruder (ZSK 30 from Werner & Pfleiderer) at from 250 to 280° C., extruded, cooled and pelletized.

The dried pellets were processed at from 260 to 280° C. to give standard small specimens, ISO test specimens, disks (60×3 mm) and sheets (1200×300×3 mm), the mold temperature being 80° C.

The heat resistance of the specimens was determined via the Vicat softening point. The Vicat softening point was determined on standard small specimens to DIN 53 460 using a force of 49.05 N and a temperature rise of 50 K per hour.

The flowability of the molding compositions was determined to DIN 53 735 at 260° C. with 5 kg load.

Fracture behavior was tested by the puncture test to DIN 53 443 at −30° C.

Notch impact strength was tested to ISO 179 1eA at room temperature, on ISO specimens.

Thermal expansion (CTE) was determined to DIN 53752, Method A, in each case on 2 test specimens (10×10×4). The values given are those measured longitudinally at 25° C.

The surface quality of the test specimens (large sheets) was observed visually, and here the following abbreviations were used:

SG: streaking close to gate

Acc: no streaking

Fiber lengths were determined as follows:

The median length (numeric median) for the fibers was determined on the ignition residue from moldings. To this end, the ignition residue was suspended in Zeiss immersion oil. To ensure that distinction was made between the filler particles and the fibers, the length of at least 100 fibers was determined manually and used to calculate the median.

The compositions and properties of the thermoplastic molding compositions 1 to 3 of the invention, and of the comparative materials c1 and c2 are found in Table 1.

TABLE 1

| | Molding | | | | | |
|---|---|---|---|---|---|---|
| | composition No. | | | | | |
| Component | | | | | | |
| [% by weight] | c1 | 1 | 2 | c2 | 3 | 4 |
| A | | | | | | |
| B1 | 61.2 | 61.2 | 61.1 | 47 | 47 | 47 |
| B2 | 6.6 | 6.6 | 6.6 | 6.5 | 6.5 | 6.5 |
| C | 6.6 | 6.6 | 6.6 | 6.5 | 6.5 | 6.5 |
| D1 | 13.1 | 13.0 | 13.0 | 13.0 | 13.0 | 13.0 |
| D2 | 12 | 11.5 | 11.5 | 12 | 11.5 | 10 |
| D3 | — | 0.5 | 0.5 | — | 0.5 | — |
| F | — | — | — | — | — | 2 |
| G | — | — | — | 14.2 | 14.2 | 14.2 |
| I1 | — | — | 0.2 | — | — | — |
| I2 | 0.5 | 0.5 | 0.5 | 0.5 | 0.5 | 0.5 |
| | — | — | — | 0.3 | 0.3 | 0.3 |
| Vicat B | 131 | 130 | 129 | 123 | 125 | 12.7 |
| [° C.] | | | | | | |
| Wₛ −30° C. | 65 | 64 | 73 | 71 | 68 | 64 |
| [Nm] | | | | | | |
| Deformation | 14.7 | 14.5 | 15.2 | 15 | 14.9 | 14.7 |
| [mm] | | | | | | |
| MVI | 11 | 12 | 11 | 17 | 19 | 18 |
| [ml/10 min] | | | | | | |
| ak | 27 | 28 | 34 | 32 | 29 | 34 |
| [kJ/m²] | | | | | | |
| CTE | 54 | 52 | 52 | 62 | 57 | 54 |
| [10⁻⁶K⁻¹] | | | | | | |
| Surface | SG | Acc | Acc | SG | Acc | Acc |
| Median fiber | — | 217 | 220 | 231 | 240 | 207 |
| length [μm] | | | | | | |

The thermoplastic molding compositions of the invention have high toughness, i.e. high penetration energy at −30° C., high notch impact strength and elongation at break, and also good flowability. Despite the use of glass fibers, the surface quality of the specimens is very good, and the addition of the fibers improves the surface in the region of the gate. The low thermal expansion of the thermoplastic molding compositions of the invention makes them suitable for producing large-surface-area parts for vehicle construction. In comparison with the respective comparative materials (1 against c1; 3 against c2) the deformation has been reduced, the MVI increased and the CTE reduced. The molding compositions of the invention therefore have an improved property profile.

We claim:

1. A thermoplastic molding composition comprising components A, B, C and D, and also, where appropriate, E, F, G and H, the entirety of which gives 100% by weight:
a) from 1 to 97.5% by weight of at least one aromatic polycarbonate A,
b) from 1 to 97.5% by weight of at least one graft polymer B made from
b1) from 40 to 80% by weight of a graft base made from an elastomeric polymer B1 based on alkyl acrylates having from 1 to 8 carbon atoms in the alkyl radical, on ethylene-propylene, on dienes or on siloxanes, and having a glass transition temperature below 0° C.,
b2) from 20 to 60% by weight of a graft B2 made from
b21) from 60 to 95% by weight of styrene or of substituted styrenes B21 of the formula I 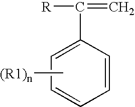
where R is C₁-C₈-alkyl or hydrogen and R¹ is C₁-C₈-alkyl and n is 1, 2 or 3, or a mixture of these, and
b22) from 5 to 40% by weight of at least one unsaturated nitrile B22,
c) from 1 to 97.5% by weight of at least one thermoplastic copolymer C made from
c1) from 60 to 85% by weight of styrene or of substituted styrenes C1 of the formula I, or mixtures of these compounds, and
c2) from 15 to 40% by weight of at least one unsaturated nitrile C2,
d) from 0.5 to 25% by weight of a mixture D made from, based on component D,
d1) from 5 to 95% by weight of at least one particulate mineral filler D1, and
d2) from 5 to 95% by weight of fibrous fillers D2, where at least 50% by weight of the fibrous fillers have a length of at least 50 μm,
e) from 0 to 10% by weight of at least one copolymer E made from at least two different alkyl, aromatic or alkylaromatic esters of acrylic acid or of methacrylic acid,
f) from 0 to 25% by weight of at least one thermoplastic polyester F,
g) from 0 to 2% by weight of at least one low-molecular-weight organic acid G,
h) from 0 to 25% by weight of at least one halogen-free phosphorus compound H,
i) from 0 to 45% by weight of other additives I.

2. A molding composition as claimed in claim 1,
wherein the polycarbonates of component A are based on biphenols of the formula II 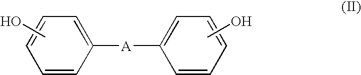
where A is a single bond, C₁-C₃-alkylene, C₂-C₃-alkylidene, C₃-C₆-cycloalkylidene, or else —S— or —SO₂—.

3. A molding composition as claimed in claim 1 or 2, wherein the graft base B1 of component B has been built up from
b11) from 70 to 99.9% by weight of at least one alkyl acrylate B11 having from 1 to 8 carbon atoms in the alkyl radical,
b12) from 0 to 30% by weight of another copolymerizable monoethylenically unsaturated monomer B12, or a mixture of these,
b13) from 0.1 to 5% by weight of a copolymerizable, polyfunctional crosslinking monomer B13,
where the entirety of components B11, B12 and B13 gives 100% by weight.

4. A molding composition as claimed in any one of claims 1 to 3, wherein component C has been built up from 70 to 85% by weight of styrene and 15 to 30% by weight of acrylonitrile.

5. A molding composition as claimed in any one of claims 1 to 4, wherein, in component D1, at least 95% by weight of the particles has a diameter below 45 μm.

6. A process for preparing molding compositions as claimed in any one of claims 1 to 5 by mixing components A to D and, where appropriate, E to I.

7. The use of molding compositions as claimed in any one of claims 1 to 5 for producing fibers, films or moldings.

8. The use as claimed in claim 7 for producing bodywork parts.

9. A molding, fiber or a film made from a molding composition as claimed in any one of claims 1 to 5.

10. A molding as claimed in claim 9 in the form of a bodywork part.
